(19) United States
(12) Patent Application Publication
(10) Pub. No.: US 2025/0104696 A1
(43) Pub. Date: Mar. 27, 2025

(54) METHOD AND APPARATUS FOR SPEECH RECOGNITION USING AI MODELS

(71) Applicants: HYUNDAI MOTOR COMPANY, Seoul (KR); KIA CORPORATION, Seoul (KR); KOREA ADVANCED INSTITUTE OF SCIENCE AND TECHNOLOGY, Daejeon (KR)

(72) Inventors: Byeong Yeol KIM, Seoul (KR); Youshin LIM, Yongin-si (KR); Jihwan PARK, Seoul (KR); Joon Son CHUNG, Daejeon (KR); Youkyum KIM, Daejeon (KR); Jaemin JUNG, Daejeon (KR); Youngjoon JANG, Daejeon (KR)

(21) Appl. No.: 18/887,348

(22) Filed: Sep. 17, 2024

(30) Foreign Application Priority Data
Sep. 21, 2023 (KR) 10-2023-0126065

(51) Int. Cl. G10L 15/06; G10L 15/08

(52) U.S. Cl. CPC G10L 15/063; G10L 15/08; G10L 2015/088

(57) ABSTRACT

A method and an apparatus for training an AI model, including generating a first keyword dataset and a second keyword dataset, pre-training the AI model using the first keyword dataset; and training the pre-trained AI model using the second keyword dataset are provided.

### CROSS-REFERENCE TO RELATED APPLICATION

This application claims priority to and the benefit of Korean Patent Application No. 10-2023-0126065 filed in the Korean Intellectual Property Office on Sep. 21, 2023, the entire contents of which are incorporated herein by reference.

### TECHNICAL FIELD

The present disclosure relates to a method and an apparatus for recognizing speech using an artificial intelligence (AI) model.

### BACKGROUND

Keyword spotting (KWS) is a technology designed to identify specific keywords in audio streams, finding applications in diverse fields such as robot interaction and smart device control. Serving as a foundational component for numerous speech support systems, the performance of a KWS system plays a crucial role in ensuring satisfactory user experience. While many existing KWS systems rely on a predefined set of keywords, the user experience can be significantly enhanced by implementing a KWS system that allows users to define their own keywords. This customization enables improved security, as distinct keywords can be assigned to individual devices, preventing unintended activations and unauthorized accesses by strangers in close proximity.

### SUMMARY

Some implementations provide a receiver of an optical communication system.

Some implementations provide an organic photoelectric conversion device.

Some implementations provide a method for transmitting an optical signal.

According to one aspect of the present disclosure, a method for training an artificial intelligence (AI) model is provided. The method may include: generating a first keyword dataset and a second keyword dataset, pre-training the AI model by using the first keyword dataset; and training the pre-trained AI model by using the second keyword dataset, wherein a number of keywords included in the first keyword dataset is greater than a number of keywords included in the second keyword dataset.

In some implementations, the generating the first keyword dataset and the second keyword dataset may include aligning words and utterance data in a first speech corpus by using an artificial neural network-based feature extractor.

In some implementations, the artificial neural network-based feature extractor may output aligned words from the words in the first speech corpus; and the aligned words may include a preceding phoneme and/or a proceeding phoneme of the words.

In some implementations, the artificial neural network-based feature extractor may output aligned words from the words in the first speech corpus; and the aligned words may include a margin of a predetermined length to the words in the first speech corpus.

In some implementations, the generating the first keyword dataset and the second keyword dataset may include: recognizing a word from aligned utterance data by using an artificial neural network-based feature extractor; and determining the first keyword dataset by filtering the recognized words.

In some implementations, the determining the first keyword dataset by filtering the recognized words may include performing the filtering based on an edit distance between the recognized word and a target word.

In some implementations, the performing the filtering based on an edit distance between the recognized word and a target word may include filtering the recognized word according to an allowable range of the edit distance determined based on a number of characters of the recognized word.

In some implementations, the generating the first keyword dataset and the second keyword dataset may include generating the second keyword dataset by using some classes of a second speech corpus, and the second speech corpus may include fewer classes than the first speech corpus.

In some implementations, the pre-training the AI model by using the first keyword dataset may include configuring a batch by using data input from the first keyword dataset.

In some implementations, the batch may include at least one positive pair of different audio data with the same keyword and at least one negative pair of audio data with different keywords.

According to another aspect of the present disclosure, an apparatus for recognizing speech by using an artificial intelligence (AI) model can include: a dataset generator configured to generate a first keyword dataset and a second keyword dataset; and an model trainer configured to pre-train an AI model by using the first keyword dataset and configured to train the pre-trained AI model by using the second keyword dataset, wherein a number of keywords included in the first keyword dataset is greater than a number of keywords included in the second keyword dataset.

In some implementations, the dataset generator may further be configured to align words and utterance data from the first speech corpus by using an artificial neural network-based feature extractor.

In some implementations, the artificial neural network-based feature extractor may output aligned words from words in the first speech corpus and the aligned words may include a preceding phoneme and/or a proceeding phoneme of the words.

In some implementations, the artificial neural network-based feature extractor may output aligned words from words in the first speech corpus and the aligned words may include a margin of a predetermined length to the words.

In some implementations, the dataset generator may further be configured to recognize words from aligned utterance data by using the artificial neural network-based feature extractor and determine the first keyword dataset by filtering the recognized words.

In some implementations, the dataset generator may further be configured to perform the filtering based on an edit distance between the recognized word and a target word.

In some implementations, the dataset generator may further be configured to filter the recognized words according to an acceptable range of the edit distances determined based on a number of characters in the recognized words.

In some implementations, the dataset generator may further be configured to generate the second keyword dataset by using some classes from the second speech corpus and the second speech corpus may include fewer classes than the first speech corpus.

In some implementations, the apparatus may further include a batch generator configured to generate at least one batch by using data input from the first keyword dataset, wherein the at least one batch configured by the batch generator may include at least one positive pair of different audio data of the same keyword and at least one negative pair of audio data of different keywords.

According to another aspect of the present disclosure, an apparatus for recognizing a word from speech can include: a feature extractor configured to generate a feature vector from the speech; and an artificial intelligence (AI) model configured to output the word from the feature vector input from the feature extractor, wherein the AI model may be pre-trained using a first keyword dataset and may further be trained using the second keyword dataset, and a number of keywords included in the first keyword dataset may be greater than a number of keywords included in the second keyword dataset.

### BRIEF DESCRIPTION OF THE DRAWINGS

FIG. 1 is a diagram illustrating an example of a speech recognition apparatus.

FIG. 2 is a flowchart illustrating an example of a method for training of an AI model for speech recognition.

FIG. 3 is a flowchart illustrating an example of a method for generating a keyword dataset.

FIG. 4A is a diagram illustrating an example of a mini-batch for pre-training of an AI model.

FIG. 4B is a diagram illustrating the pre-training results of the AI model.

FIG. 5 is a diagram illustrating an example of an artificial neural network running an AI model.

FIG. 6 is a block diagram illustrating an example of a speech recognition apparatus.

### DETAILED DESCRIPTION

An artificial intelligence model (AI model) of the present disclosure may be a machine learning model for learning at least one task, which may be implemented as a computer program executed by a processor. The task being trained by the AI model may refer to either the problem to be solved with the machine learning or the work you want to perform with the machine learning. The AI model may be implemented as a computer program running on a computing device, downloaded over a network, or sold a computer program product. Alternatively, the AI model may work with variety of devices over a network.

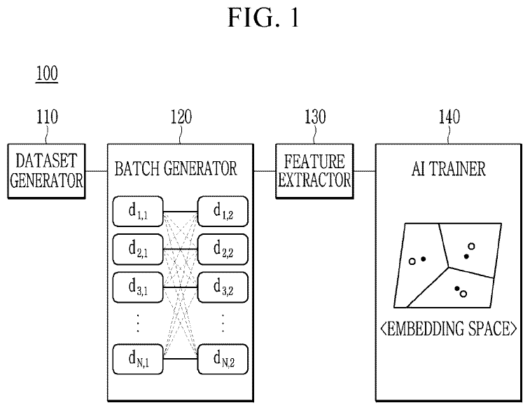

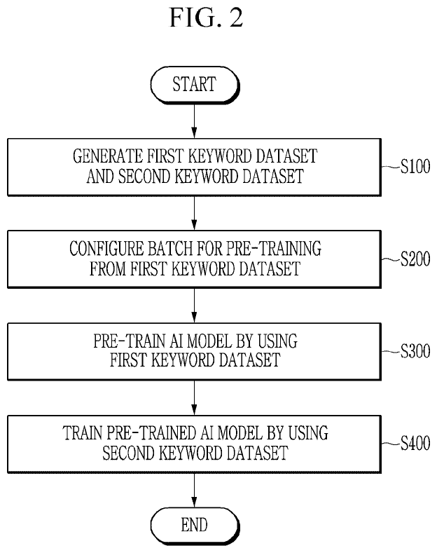

FIG. 1 is a diagram illustrating a speech recognition apparatus 100, and FIG. 2 is a flowchart illustrating a method for training of an AI model for speech recognition.

The speech recognition apparatus 100 may include a dataset generator 110, a batch generator 120, a feature extractor 130, and a model trainer 140.

The dataset generator 110 may generate a large scale dataset for pre-training of an artificial intelligence (AI) model and a small scale dataset for fine-tuning of the pre-trained AI model. The large scale dataset for pre-training of the AI model may include the relatively large number of training classes, for example, for metric learning of the speech recognition apparatus.

The large-scale dataset for the pre-training of the AI model may be generated from keyword data outside the domain (out-of-domain), and then the small-scale dataset for the fine tuning of the AI model from keyword data within the domain (intra-domain) may be generated. Here, the domain may an embedding space where tests on the AI model are performed. That is, the pre-training of the AI model for keyword spotting may be performed by using data outside the domain, and the fine tuning of the AI model for the keyword spotting may be performed by using data within the domain. Here, the dataset for the fine-tuning of the AI model may be within the domain, but may not overlap with the dataset for the testing.

In some implementations, a large-scale out-of-domain corpus may include 1,000 keywords extracted from the LibriSpeech corpus. Additionally, the small-scale dataset may include 25 keywords extracted from the Google speech command (GSC) corpus. The dataset generator 110 may exclude user-defined keywords from the large-scale dataset and the small-scale dataset.

The batch generator 120 may configure at least one batch for the pre-training of the AI model from the large-scale dataset. Metric learning may be applied to the pre-training of the AI model.

Referring to FIG. 1, in the batch configuration, d_{i,j} may represent single audio data obtained from the large-scale dataset and N may represent the size of a mini-batch. In the connection of d_{i,j}, a solid line may represent a positive pair and a dotted line may represent a negative pair. In some implementations, the positive pair may include different audio data of the same keyword and the negative pair may include audio data of different keywords within one mini-batch. In the prototype network, each mini-batch may include at least two samples (audio data) corresponding to each keyword.

The feature extractor 130 may normalize appearance of data input to the model trainer 140. In some implementations, the feature extractor 130 may limit the maximum length of the 16 KHz waveform to 1 second. For example, when the audio data is longer than 1 second, the feature extractor 130 may cut the audio data to a length of 1 second and when the audio data is shorter than 1 second, the feature extractor 130 may perform zero padding on the audio data.

In some implementations, the feature extractor 130 may extract a feature value of sound from normalized audio data. For example, the feature extractor 130 may extract a mel-frequency cepstral coefficient (MFCC) from the normalized audio data. The feature extractor 130 may extract a 40-dimensional MFCC from the normalized audio data using a window of 30 ms and a frame shift of 10 ms.

The model trainer 140 may train an artificial intelligence (AI) model using the datasets generated by the dataset generator 110 so that it recognizes keywords (e.g., wakeup words) within human voices. In some implementations, the model trainer 140 may train the AI model on the large-scale dataset (pre-training) and the model trainer 140 may then train the pre-trained AI model on the small-scale dataset generated by the dataset generator 110 (fine-tuning). The model trainer 140 may train (including the pre-training and the fine-tuning) the AI model by updating weight values and parameters of the AI model so that the output of the objective function is minimized.

For training of the AI model, at least one of a Softmax function and a metric learning-based objective function may be used. The metric learning-based objective function may include an additive margin softmax (AM-Softmax) function and an angular prototypical (AP) function.

Referring to FIG. 2, the dataset generator 110 may generate a first keyword dataset and a second keyword dataset for the pre-training and the fine-tuning of the AI model, respectively S100.

The batch generator 120 may generate a batch for the pre-training of the model from the first keyword dataset S200.

The model trainer 140 may train the AI model on the first keyword dataset (pre-training) S300. In some implementations, metric learning may be performed for training of the AI model. Afterwards, the model trainer 140 may train the pre-trained AI model on the second keyword dataset (fine-tuning of the pre-trained AI model) S400. The model trainer 140 may perform the pre-training and/or the fine-tuning for the AI model using at least one of the softmax function, the AM-softmax function, and the AP function.

The fine-tuning for the AI model may be performed using the small keyword dataset to have improved representation of the speech corpus of the small keyword dataset. In other words, the fine-tuning may be performed using the small keyword dataset to reflect channel characteristics of the in-domain to the representation.

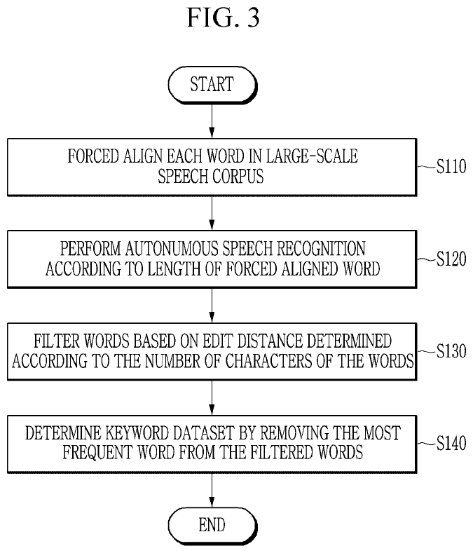

FIG. 3 is a flowchart illustrating a method for generating a keyword dataset.

The dataset generator 110 may generate the first keyword data for pre-training of an AI model from a speech corpus (e.g., English corpus such as LibriSpeech corpus, Korean Speech Commands (KSC)). The LibriSpeech corpus may contain 1,000 hours of utterance data and keywords sampled at 16 KHz.

In some implementations, the metric learning may be performed on the AI model so that discriminative features can be included in the unseen space of data samples. A large number of training classes (e.g., keywords or words) may be required to train effective representations by the metric learning. In some implementations, the dataset generator 110 may extract about 1,000 keywords from the LibriSpeech corpus and generate the first keyword dataset using the extracted keywords.

Referring to FIG. 3, the dataset generator 110 may perform forced alignment (segmentation of individual words and utterance data) on individual words and utterance data of the speech corpus S110.

In some implementations, the dataset generator 110 may use an artificial neural network-based feature extractor to perform the forced alignment for the individual words in the speech corpus. In some implementations, the dataset generator 110 may perform the forced alignment for the individual words in utterance-level labels by using the artificial neural network-based feature extractor.

The artificial neural network-based feature extractor may include at least one of Wav2Vec, SincNet, and Problem-Agnostic Speech Encoder (PASE), which generate feature vectors from speech.

Force-aligned words may further include a margin of a predetermined length to include noise or utterances that may occur before or after the keyword in an actual scenario. The margin of the predetermined length may be 6% of the length of the audio corresponding to the word. By including the margin in the force-aligned word, the audio output from the artificial neural network-based feature extractor may further include preceding phonemes and/or proceeding phonemes of the force-aligned word. For example, an artificial neural network-based feature extractor may add a margin to ‘love’ and output ‘I love you’ as the forced aligned word.

Afterwards, the dataset generator 110 may perform filtering based on an edit distance to improve the quality of the forced-aligned words. The edit distance may represent the distance between the word recognition result and a target word (keyword).

In some implementations, the dataset generator 110 may recognize words from segmented utterance data using the artificial neural network-based feature extractor S120. The dataset generator 110 may filter, based on the edit distance, words that are not considered to be data suitable for model learning, that is, words that are incorrectly aligned S130. In some implementations, the dataset generator 110 may filter recognized words according to an allowable range of the edit distance range determined based on the number of characters in the recognized words.

In some implementations, the dataset generator 110 may allow the edit distance of up to 1 when a word has two or fewer characters and may allow the edit distance of up to 3 when a word has more than two characters. For example, when the segmented utterance is ‘love’ and the speech recognition result of ‘love’ is LEOVE, the dataset generator 110 may allow the edit distance of up to 3 and may not filter the LEOVE because the edit distance of LEOVE and love is 1.

Referring to FIG. 3, the dataset generator 110 may determine the first keyword dataset by removing some of the most frequently appearing words (the most frequent words) from the filtered words S140. In some implementations, the dataset generator 110 may remove the most frequent words from the filtered words by determining the most frequent word in the speech corpus as an article and/or preposition. For example, the dataset generator 110 may remove the 17 most frequent words from the filtered words and determine a predetermined number (e.g., 1,000) of words among the remaining words as the first keyword dataset. In some implementations, there may be 1,601,226 utterance data corresponding to 1000 words in the first keyword dataset.

The dataset generator 110 may generate the second keyword dataset for the fine-tuning of the pre-trained AI model using a speech corpus different from the speech corpus used to generate the first keyword dataset. The other speech corpus may contain fewer classes (or keywords) than the speech corpus used to generate the first keyword dataset.

In some implementations, the other speech corpus used to generate the second keyword dataset may be the GSC. The GSC is a publicly available KWS dataset that contains 105,829 utterance data (about 2,000 or more for each keyword) for 35 keywords. Table 1 below shows the keywords included in the GSC divided into three groups.

TABLE 1

| dataset | | # of classes | keywords |
|---|---|---|---|
| Training set | pre-defined | 10 | ‘Yes', ‘No’, ‘Up’, ‘Down’, ‘Left’, ‘Right’, |
| | | | ‘On’, ‘Off’, ‘Stop’, ‘Go’ |
| | Unknown | 15 | ‘Bed’, ‘Bird’, ‘Cat’, ‘Dog’, ‘Wow’, ‘House’, |
| | | | ‘Learn’, ‘Sheila’, ‘Tree’, ‘Happy’, ‘Marvin’, |
| | | | ‘Backward’, ‘Follow’, ‘Forward’, ‘Visual’ |
| Test set | User-defined | 10 | ‘Zero’, ‘One’, ‘Two’, ‘Three’, ‘Four’, ‘Five’, |
| | | | ‘Six’, ‘Seven’, ‘Eight’, ‘Nine’ |

Referring to Table 1, the dataset generator 110 may train (i.e., fine-tuning) the pre-trained AI model using the training set of 35 keywords of the GSC divided into three groups. The unknown keywords in the training set may be a set of utterances that may occur in a real environment. In other words, the predefined keywords and the unknown keywords (25) may be used for fine-tuning of the pre-trained AI model and the user-defined keywords may be used when testing the trained AI model. Therefore, the 10 keywords in the test set may be deleted from the first keyword dataset.

In some implementations, the dataset generator 110 may perform the keyword dataset generation process on the speech corpus of languages other than English and may use the keyword dataset of the other languages to pre-train the AI model along with the first keyword dataset. For example, the dataset generator 110 may generate a Korean keyword dataset for the KSC corpus and use the first keyword dataset and the Korean keyword dataset together for pre-training of the AI model. The KSC corpus may contain 4,000 hours of utterance data sampled at 48 KHz.

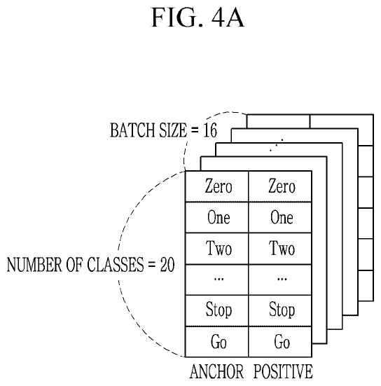

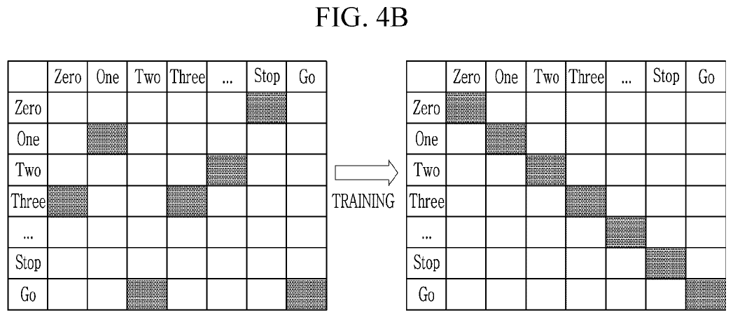

FIG. 4A is a diagram illustrating a mini-batch for pre-training of an AI model and FIG. 4B is a diagram illustrating the pre-training results of the AI model.

Referring to FIG. 4A, the batch size is 16 and each mini-batch may include 20 classes (keywords). Each class may include a pair of anchor and positive.

Referring to FIG. 4B, through the results of the pre-training of the model trainer 140, the AI model may have representations between all input keywords. As a loss function for the pre-training, a metric based on cosine similarity and an angular prototypical (AP) function may be used. Equation 1 represents the AP function.

$${L}_{AP} = - \frac{1}{N} {\sum }_{j = 1}^{N} log \frac{{e}_{j , j}^{S}}{{\sum }_{k = 1}^{N} {e}_{j , k}^{S}} \qquad ( Equation 1 )$$

In equation 1, the squared Euclidean distance metric of the general prototype loss function is replaced by the cosine distance. Each mini-batch may include a support set S and a query set Q and each query may be assumed to be M-th utterance from all keywords. Equation 2 may represent the prototype at this time and equation 3 may represent a cosine-based similarity metric with a learnable scale and bias.

$${c}_{k} = \frac{1}{M - 1} {\sum }_{i = 1}^{M - 1} {e}_{k , i} \qquad ( Equation 2 )$$

$${S}_{j , k} = w \cdot cos ( {e}_{j , M} , {c}_{k} ) + b$$

During the pre-training, each query example may be classified into N classes based on the output of the softmax function according to the distance to each keyword prototype.

In some implementations, a loss function different from the AP function may be used alone or with/without the AP function for the pre-training and/or the fine-tuning of the AI model. In some implementations, the softmax function and/or the AM-softmax function may be used for the pre-training and/or the fine-tuning of the AI model.

The softmax loss function may be used to train a classification network. In some implementations, the softmax loss function may be used as the reference objective function. The softmax loss function may include a softmax function and a multi-class cross-entropy loss function. Equation 4 represents the softmax loss function.

$${L}_{S} = - \frac{1}{N} {\sum }_{i = 1}^{N} log \frac{{e}^{{W}_{{y}_{i}}^{T} {x}_{i} + {b}_{{y}_{i}}}}{{\sum }_{j = 1}^{C} {e}^{{W}_{j}^{T} {x}_{i} + {b}_{j}}} \qquad ( Equation 4 )$$

In equation 4, W and b may be learnable parameters. The softmax loss function may not explicitly enforce intra-class compactness and interclass separation.

The additive margin softmax (AM-Softmax) loss function may be a loss function that introduces a margin to the softmax loss function. The margin introduced in the softmax loss function may improve performance in few-shot learning work by down-sizing within classes and strengthening separation between classes.

First, the weight value and input vector may be normalized in the softmax loss, so that the posterior probability may only depend on the cosine value of the angle between the weight value and input vector.

$${L}_{N} = - \frac{1}{N} {\sum }_{i = 1}^{N} log \frac{{e}^{cos ( {θ}_{{y}_{i} , i} )}}{{\sum }_{j} {e}^{cos ( {θ}_{j , i} )}} \qquad ( Equation 5 )$$

In equation 5, cos(θ_{j,i}) may be calculated from the dot product of the normalized weight value vector Wⱼ and input xᵢ. In equation 5, only classification errors may be penalized, so the embedding according to equation 5 may still not be sufficiently discriminatory. To solve this problem, a cosine margin m may be added as shown in equation 6 below.

$${L}_{C} = - \frac{1}{N} {\sum }_{i = 1}^{N} log \frac{{e}^{s ( cos ( {θ}_{{y}_{i} , i} ) - m )}}{{e}^{s ( cos ( {θ}_{{y}_{i} , i} ) - m )} + {\sum }_{j \neq {y}_{i}} {e}^{s ( cos ( {θ}_{j , i} ) )}} \qquad ( Equation 6 )$$

In equation 6, s is a fixed scale coefficient to prevent the slope from becoming too small during the training phase.

In some implementations, the AP loss function may be used in the pre-training of the AI model and at least one of the softmax loss function, the AM-softmax loss function, and the AP loss function may be used for the fine-tuning of the AI model.

In some implementations, the trained AI model trained by the model trainer 140 may be tested using a user-defined dataset. The user-defined dataset is part of the GSC and may not overlap with the training set.

When the user-defined dataset is input, the trained AI model of the speech recognition apparatus 100 may infer the keyword indicated by the utterance data of the input dataset, so that the keyword spotting performance of the trained model may be tested. Table 2 shows the inference performance of speech recognition apparatus 100 measured when various loss functions is applied to the pre-training and the fine-tuning.

TABLE 2

| Training loss | | | | | | |
|---|---|---|---|---|---|---|
| Pre-train | Fine-tune | EER ↓ | Acc ↑ | F1-score ↑ | FRR@FAR = 2.5 ↓ | FRR@FAR = 10 ↓ |
| w/Inc. Training | | 9.0† | — | — | 17.0† | 8.3† |
| — | Softmax | 8.27 | 86.17 | 0.86 | 25.13 | 6.80 |
| | AM-Soft | 8.43 | 85.87 | 0.86 | 21.23 | 7.33 |
| | AP | 8.90 | 80.00 | 0.80 | 24.77 | 8.00 |
| Softmax | — | 21.67 | 62.30 | 0.63 | 53.37 | 34.50 |
| | Softmax | 9.30 | 87.90 | 0.88 | 21.13 | 8.97 |
| | AM-Soft | 4.07 | 94.37 | 0.94 | 6.93 | 2.40 |
| | AP | 4.10 | 95.10 | 0.95 | 5.57 | 2.20 |
| AM-Soft | — | 22.44 | 66.00 | 0.67 | 71.50 | 41.10 |
| | Softmax | 13.37 | 75.33 | 0.76 | 33.43 | 17.37 |
| | AM-Soft | 5.37 | 93.43 | 0.93 | 9.50 | 2.73 |
| | AP | 4.37 | 94.03 | 0.94 | 6.03 | 2.47 |
| AP | — | 23.08 | 67.20 | 0.69 | 76.07 | 48.20 |
| | Softmax | 9.40 | 84.20 | 0.76 | 29.83 | 15.67 |
| | AM-Soft | 3.73 | 95.20 | 0.95 | 4.60 | 1.90 |
| | AP | 3.20 | 95.57 | 0.96 | 4.03 | 1.37 |

Referring to Table 2, it can be seen that the pre-training on the large-scale out-of-domain data improves the inference performance of the speech recognition apparatus 100. When training using the AP loss function is performed in both the pre-training and the fine-tuning, EER (Equal Error Rate) shows the best performance at 3.20% and the accuracy of speech recognition shows the best performance at 95.57%. Additionally, FRR (False Rejection Rate) @FAR (False Alarm Rate) also shows the best performance in the case of the pre-training and the fine-tuning by the AP loss function.

Table 3 shows a performance comparison of speech recognition apparatus 100 according to the type of first keyword dataset.

TABLE 3

| Dataset | # Classes | # Samples | EER ↓ | Acc ↑ | F1-score ↑ | FRR@FAR = 2.5 ↓ | FRR@FAR = 10 ↓ |
|---|---|---|---|---|---|---|---|
| FIRST | 500 | 1,000 | 5.10 | 93.13 | 0.93 | 9.43 | 2.40 |
| KEYWORD | 1,000 | 500 | 4.22 | 94.03 | 0.94 | 5.77 | 1.73 |
| DATASET | 1,000 | 1,000 | 3.20 | 95.57 | 0.96 | 4.03 | 1.37 |
| FIRST + | 2, (XX) | 1,000 | 2.98 | 96.00 | 0.96 | 3.43 | 1.00 |
| SECOND | | | | | | | |

Referring to Table 3, when the number of samples per keyword (class) is reduced or the number of keywords per sample is reduced, the keyword spotting performance of the speech recognition apparatus 100 may be deteriorated. As the number of classes decreases, the keyword spotting performance of the speech recognition apparatus 100 may degrade further more than if only the number of samples is decreased. Therefore, the number of classes may be a more important factor than the number of samples in order for the AI model to successfully make inferences on unseen user-defined keywords.

In addition, when the number of classes increases by adding the second keyword dataset generated from the Korean speech corpus to the first keyword dataset generated from the English speech corpus, the keyword spotting performance of the speech recognition apparatus 100 can be further improved.

As described above, the pre-training and the fine-tuning for the AI model are performed using the different keyword datasets generated from a corpus outside the domain and a corpus within the domain, respectively, improving inference and detection performance for words of the speech in the discriminable embedding space.

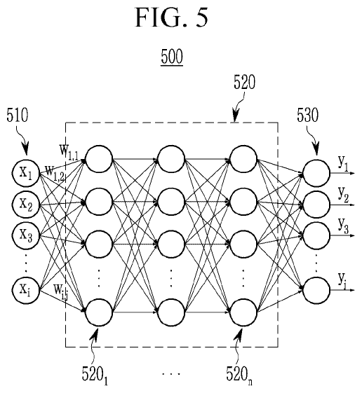

FIG. 5 is a diagram illustrating an artificial neural network running an AI model.

Referring to FIG. 5, an artificial neural network (ANN) 500 may include an input layer 510, a hidden layer 520, and an output layer 530. Each of the input layer 510, the hidden layer 520, and the output layer 530 may include a plurality of nodes, and the strength of the connection between each node may correspond to a weight value (weight connection). The plurality of nodes included in the input layer 510, the hidden layer 520, and the output layer 530 may be fully connected to each other. In some implementations, the number of parameters (weight value and bias) may be equal to the number of weight value connections within the artificial neural network 500.

The input layer 510 may include a plurality of input nodes (x₁ to xᵢ), and the number of input nodes (x₁ to xᵢ) may correspond to the number of independent variables. For training of the artificial neural network 500, the training dataset is input to the input layer 510. When the test dataset is input to the input layer 510 of the trained artificial neural network 500, the inference result for the test dataset may be output from the output layer 530 of the trained artificial neural network 500.

The hidden layer 520 is positioned between the input layer 510 and the output layer 530 and may include at least one hidden layer (520₁ to 520ₙ). The output layer 530 may include at least one output node (y₁ to yⱼ). An activation function may be used in the hidden layer 520 and output layer 530. In some implementations, the artificial neural network 500 may be trained by adjusting the weight value of hidden nodes included in the hidden layer 520.

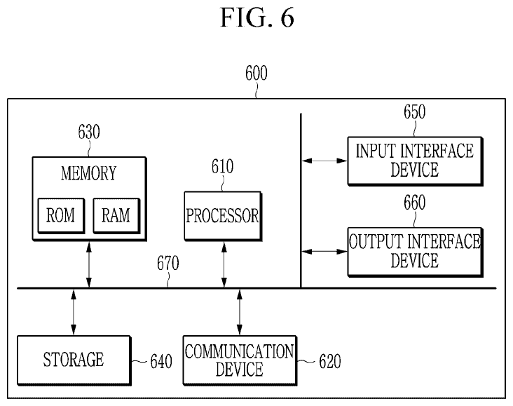

FIG. 6 is a block diagram illustrating a speech recognition apparatus.

The speech recognition apparatus according to some exemplary implementations may be implemented as a computer system, for example, a computer-readable medium. Referring to FIG. 6, the computer system 600 may include at least one of a processor 610, a memory 630, an input interface device 650, an output interface device 660, or a storage device 640 communicating through a bus 670. The computer system 600 may also include a communication device 620 coupled to the network. The processor 610 may be a central processing unit (CPU) or a semiconductor device that executes instructions stored in the memory 630 or the storage device 640. The memory 630 and the storage device 640 may include various forms of volatile or nonvolatile storage media. For example, the memory may include read only memory (ROM) or random-access memory (RAM). In some implementations of the present inventive concepts, the memory may be located inside or outside the processor, and the memory may be coupled to the processor through various means already known. The memory is a volatile or nonvolatile storage medium of various types, for example, the memory may include read-only memory (ROM) or random-access memory (RAM).

Accordingly, some exemplary implementations may be implemented as a method implemented in the computer, or as a non-transitory computer-readable medium in which computer executable instructions are stored. In some implementations, when executed by a processor, the computer-readable instruction may perform the method according to at least one aspect of the present inventive concepts.

The communication device 620 may transmit or receive a wired signal or a wireless signal.

Some exemplary implementations are not implemented only by the apparatuses and/or methods described so far, but may be implemented through a program realizing the function corresponding to the configuration of some exemplary implementations of the present inventive concepts or a recording medium on which the program is recorded. Such exemplary implementations can be easily implemented by those skilled in the art from the description of some exemplary implementations described above. Specifically, methods (e.g., network management methods, data transmission methods, transmission schedule generation methods, etc.) according to some exemplary implementations of the present inventive concepts may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for some exemplary implementations of the present inventive concepts or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like.

Program instructions may include machine language code such as those produced by a compiler, as well as high-level language code that may be executed by a computer via an interpreter, or the like.

The components described in some exemplary implementations may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in some exemplary implementations may be implemented by software, and the software may be recorded on a recording medium. The components, the functions, and the processes described in some exemplary implementations may be implemented by a combination of hardware and software. The method according to some exemplary implementations may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages, and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system OS and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements.

For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

As described herein, any devices, electronic devices, modules, units, circuits, and/or portions thereof according to any of the exemplary implementations, and/or any portions thereof (including, without limitation, the speech recognition apparatus 100, the dataset generator 110, the batch generator 120, the feature extractor 130, the model trainer 140, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some exemplary implementations, the processing circuitry may include a non-transitory computer readable storage device (e.g., a memory), for example a solid state drive (SSD), storing a program of instructions, and a processor (e.g., a CPU) configured to execute the program of instructions to implement the functionality and/or methods performed by some or all of any devices, electronic devices, modules, units, circuits, and/or portions thereof, according to any of the exemplary implementations, including any of the methods according to any of the exemplary implementations.

Any of the memories described herein may be a non-transitory computer readable medium and may store a program of instructions. Any of the memories described herein may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM).

The present specification includes details of a number of specific implements, but it should be understood that the details do not limit any inventive concepts or what is claimable in the specification but rather describe features of some exemplary implementations.

Features described in the specification in the context of individual exemplary implementations may be implemented as a combination in one or more single exemplary implementations. In contrast, various features described in the specification in the context of a single exemplary implementation may be implemented in multiple exemplary implementations individually or in an appropriate sub-combination.

Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described exemplary implementations in all exemplary implementations, and it should be understood that the above-described program components and apparatuses may be incorporated into a single software product or may be packaged in multiple software products.

While the inventive concepts have been described in connection with what is presently considered to be practical exemplary implementations, it is to be understood that the inventive concepts are not limited to such exemplary implementations. On the contrary, the inventive concepts are intended to cover various modifications and equivalent arrangements included within the spirit and scope of the appended claims.

What is claimed is:

1. A method for training an artificial intelligence (AI) model, the method comprising:
generating a first keyword dataset and a second keyword dataset,
pre-training the AI model based on the first keyword dataset; and
refining the pre-trained AI model through training with the second keyword dataset,
wherein a number of keywords included in the first keyword dataset is greater than a number of keywords included in the second keyword dataset.

2. The method of claim 1, wherein generating the first keyword dataset and the second keyword dataset comprises aligning a plurality of words and utterance data within a first speech corpus using an artificial neural network-based feature extractor.

3. The method of claim 2,
wherein the artificial neural network-based feature extractor is configured to:
output the aligned plurality of words including at least one of a preceding phoneme or a proceeding phoneme of the words.

4. The method of claim 2,
wherein the artificial neural network-based feature extractor is configured to output the aligned plurality of words including a margin of a predetermined length relative to the plurality of words within the first speech corpus.

5. The method of claim 2, wherein generating the first keyword dataset and the second keyword dataset comprises:
identifying a word from the aligned utterance data through the artificial neural network-based feature extractor, and
determining the first keyword dataset by filtering the identified word.

6. The method of claim 5, wherein determining the first keyword dataset by filtering the identified word comprises:
performing the filtering based on an edit distance between the identified word and a target word.

7. The method of claim 6, wherein performing the filtering based on the edit distance comprises:
filtering the identified word based on an allowable range of the edit distance determined by a number of characters of the identified word.

8. The method of claim 2, wherein generating the first keyword dataset and the second keyword dataset comprises:
generating the second keyword dataset based on a plurality of classes within a second speech corpus, the second speech corpus including fewer classes compared to the first speech corpus.

9. The method of claim 1, wherein pre-training the AI model based on the first keyword dataset comprises configuring a batch using data from the first keyword dataset.

10. The method of claim 9, wherein the batch includes at least one positive pair and at least one negative pair, the at least one positive pair including distinct audio data sharing a same keyword, and the at least one negative pair including audio data with different keywords.

11. An apparatus configured to identify speech based on an artificial intelligence (AI) model, the apparatus comprising:
a dataset generator configured to generate a first keyword dataset and a second keyword dataset; and
a model trainer, implemented using one or more computing devices, configured to (i) pre-train an AI model based on the first keyword dataset and (ii) refine the pre-trained AI model through training with the second keyword dataset,
wherein a number of keywords included in the first keyword dataset is greater than a number of keywords included in the second keyword dataset.

12. The apparatus of claim 11, wherein generating the first keyword data and the second keyword dataset comprises aligning a plurality of words and utterance data within a first speech corpus using an artificial neural network-based feature extractor.

13. The apparatus of claim 12, wherein the artificial neural network-based feature extractor is configured to output the aligned plurality of words including at least one of a preceding phoneme or a proceeding phoneme of the words.

14. The apparatus of claim 12, wherein the artificial neural network-based feature extractor is configured to output the aligned plurality of words including a margin of a predetermined length relative to the plurality of words within the first speech corpus.

15. The apparatus of claim 12, wherein generating the first keyword dataset and the second keyword dataset comprises:
identifying a word from the aligned utterance data through the artificial neural network-based feature extractor, and
determining the first keyword dataset by filtering the identified word.

16. The apparatus of claim 15, wherein determining the first keyword dataset by filtering the identified word comprises performing the filtering based on an edit distance between the identified word and a target word.

17. The apparatus of claim 16, wherein performing the filtering based on the edit distance comprises filtering the identified word based on an allowable range of the edit distance determined by a number of characters of the identified word.

18. The apparatus of claim 12, wherein generating the first keyword dataset and the second keyword dataset comprises:
generating the second keyword dataset based on a plurality of classes within a second speech corpus, the second speech corpus including fewer classes compared to the first speech corpus.

19. The apparatus of claim 11, further comprising:
a batch generator, implemented using one or more computing devices, configured to generate at least one batch by using data from the first keyword dataset,
wherein the at least one batch includes at least one positive pair and at least one negative pair, the at least one positive pair including distinct audio data sharing a same keyword, and the at least one negative pair including audio data of different keywords.

20. An apparatus configured to identify a word from speech, the apparatus comprising:
a feature extractor configured to generate a feature vector from the speech; and
an artificial intelligence (AI) model configured to output the word from the feature vector,
wherein the AI model is pre-trained based on a first keyword dataset and is further refined through training with a second keyword dataset, and a number of keywords included in the first keyword dataset is greater than a number of keywords included in the second keyword dataset.
